(19) United States
(12) Patent Application Publication
(10) Pub. No.: US 2026/0241460 A1
(43) Pub. Date: Aug. 20, 2026

(54) CUTTING INSERT

(71) Applicant: KYOCERA CORPORATION, Kyoto-shi, Kyoto (JP)

(72) Inventor: Delin ZHU, DONGUANN, GUANGDONG (CN)

(21) Appl. No.: 19/160,863

(22) PCT Filed: Mar. 5, 2024
(86) PCT No.: PCT/CN2024/080026

§ 371 Date: Aug. 29, 2025

(30) Foreign Application Priority Data
Mar. 30, 2023 (CN) 202310335657.2

(51) Int. Cl. B23B 27/04

(52) U.S. Cl. CPC B23B 27/045; B23B 2200/081; B23B 2200/321

(57) ABSTRACT

A cutting insert has a front surface, an upper surface, side surfaces, a front cutting edge, and side cutting edges. The upper surface has a first front region, a second front region, first side regions, and second side regions. The first front region is connected to the front cutting edge. The second front region is connected to the first front region. The first side regions are connected to the side cutting edges. The second side regions are connected to the first side regions. The ends of the joint of the first front region and the second front region close to the side cutting edges are first ends. The ends of the joints of the first side regions and the second side regions close to the front cutting edge are second ends. The first ends are farther away from the front cutting edge than the second ends.

### CROSS-REFERENCE TO RELATED APPLICATIONS

This application is national stage application of International Application No. PCT/CN2024/080026, filed on Mar. 5, 2024, which designates the United States, and which claims the benefit of priority from Chinese Patent Application No. 202310335657.2, filed on Mar. 30, 2023.

### TECHNICAL FIELD

The invention relates to the technical field of mechanical processing, and particularly to a cutting insert.

### BACKGROUND

In many prior arts, an upper surface of the grooving insert is provided with a chip breaker groove, and the chip breaker groove is provided with a protrusion. When processing materials such as carbon steel and alloy steel, in order to control chips easily, the protrusion is disposed relatively close to, or even adjacent to the cutting edge.

As described in Patent CN102596459 B, the protrusion on the upper surface of the insert is relatively close to the cutting edge. Such an insert exhibits a relatively good effect on chip control when processing the materials with proper hardness such as carbon steel and alloy steel. However, when processing materials with low hardness such as soft steel and aluminium alloy, the insert fails to control chips ideally due to the production of relatively soft chips. Additionally, a space for chip control between the protrusion and the cutting edge is relatively limited because the protrusion is relatively close to the cutting edge, and the chip adhesion phenomenon is more likely to occur when processing materials such as soft steel and aluminium alloy.

### SUMMARY

An object of the present invention is to provide a cutting insert which is capable of enabling chips to be curled easily and be evacuated smoothly, thereby avoiding the chip adhesion phenomenon.

In order to solve the above technical problem, the present invention adopts the following technical solution:
a cutting insert extending from a front end to a rear end, including:
a front surface located at the front end,
an upper surface connected to the front surface,
a side surface connected to the front surface and the upper surface,
a front cutting edge located at an intersection of the front surface and the upper surface, and
a side cutting edge located at an intersection of the side surface and the upper surface;
the upper surface includes:
   a first front region connected to the front cutting edge and inclined downward,
   a second front region connected to the first front region and inclined downward,
   a first side region connected to the side cutting edge and inclined downward,
   a second side region connected to the first side region and inclined downward;
where an end of a junction between the first front region and the second front region, close to the side cutting edge is defined as a first end,
an end of the junction between the first side region and the second side region, close to the front cutting edge is defined as a second end, and the first end is further away from the front cutting edge than the second end.

In an embodiment, the junction between the first front region and the second front region as a whole is further away from the front cutting edge than the second end.

In an embodiment, a height of the first end is lower than a height of the second end, and the first end is located below the second end.

In an embodiment, the first end is further away from the side cutting edge than the second end.

In an embodiment, the first front region and the second front region are flat, respectively.

In an embodiment, the first side region and the second side region are flat, respectively.

In an embodiment, the first side region includes a first outer part and a second outer part further away from the front cutting edge than the first outer part;
the second side region includes a first inner part and a second inner part, the first inner part is connected to the first outer part, the second inner part is connected to the second outer part;
the first outer part and the first inner part are further away from the front cutting edge than the second front region; and
a width of the first outer part is less than a width of the first inner part, and a width of the second outer part is greater than a width of the second inner part.

In an embodiment, the first side region includes a third outer part closer to the anterior cutting edge than the first outer part;
the second side region includes a third inner part closer to the front cutting edge than the first inner part; and
the third inner part is connected to the first front region and the second front region, respectively, and a maximum width of the third inner part is greater than a width of the third outer part.

In an embodiment, the width of the first outer part is less than a width of the first front region, and the width of the second outer part is greater than the width of the first front region.

In an embodiment, the upper surface is provided with a protrusion between the two side cutting edges; the protrusion is elongated, and extends from rear to front, the protrusion is gradually increased in height and forms a peak at a front end of the protrusion, and a front side surface of the peak gradually slopes downward and is in transitional connection with the second front region.

In an embodiment, a height of the peak is lower than a height of the side cutting edge.

As can be seen from the above technical solution, the present invention has at least the following advantages and positive effects: in the cutting insert of the present invention, the region of the upper surface close to the front cutting edge has a first front region and a second front region, and the upper surface is formed with a plurality of front regions between the upper surface and the front cutting edge. The region of the upper surface close to the side cutting edge includes a first side region and a second side region. Therefore, a plurality of side regions and a plurality of front regions increase the space of the upper surface. Furthermore, the second front region is inclined downward more steeply relative to the first front region, and the inclination angle of the second front region is greater than the inclination angle of the first front region when the chips are sequentially moved along the plurality of front regions and the plurality of side regions, ensuring a sufficient space for curling the chips, and allowing the chips to be curled smoothly due to the relatively large space for curling the chips.

Furthermore, the first end is further away from the front cutting edge than the second end, so that the second side region is closer to the front cutting edge, the second side region may contact the chips earlier, facilitating inward curling and shaping of the chips, so that the chips may be smoothly evacuated, avoiding the occurrence of chip adhesion.

### BRIEF DESCRIPTION OF THE DRAWINGS

FIG. 1 is a perspective view of a cutting insert according to this embodiment;

FIG. 2 is a perspective view of the cutting insert mounted on a shank according to this embodiment;

FIG. 3 is a top view of the cutting insert shown in FIG. 1;

FIG. 4 is a bottom view of the cutting insert shown in FIG. 1;

FIG. 5 is a side view of the cutting insert shown in FIG. 1;

FIG. 6 is a side view of the cutting insert shown in FIG. 5;

FIG. 7 is an enlarged view of the portion M of the cutting insert shown in FIG. 1;

FIG. 8 is a partial enlarged view of the cutting part shown in FIG. 3;

FIG. 9 is a sectional view of the cutting insert taken along line A-A in FIG. 3;

FIG. 10 is a sectional view of the cutting insert taken along line C-C in FIG. 5;

FIG. 11 is a top view in another direction of the cutting insert shown in FIG. 1;

FIG. 12 is a sectional view of the cutting insert taken along line F-F in FIG. 11;

FIG. 13 is a sectional view of the cutting insert taken along line G-G in FIG. 11;

FIG. 14 is a schematic view of the cutting insert shown in FIG. 1 in a grooving operation;

FIG. 15 is a schematic view of the cutting insert shown in FIG. 1 in a shoulder grooving operation; and

FIG. 16 is a schematic view of the cutting insert shown in FIG. 1 in a transverse cutting operation.

### DETAILED DESCRIPTION

Exemplary embodiments embodying features and advantages of the present invention will be described in detail in the following description. It should be understood that the present invention is capable of having various changes in various embodiments without departing from the scope of the invention, and that the description and illustrations therein are intended to be construed as illustrative in nature and are not intended to limit the invention.

In the description of the this application, it is to be understood that terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” and “counterclockwise” indicate orientations or positional relationships based on those shown in the drawings, merely for ease of description and simplification, and do not indicate or imply that the device or element must have a specific orientation or be constructed and operated in a specific orientation, and thus should not be construed as limiting the present application. Furthermore, the terms “first” and “second” are used only for the purpose of description, and are not to be understood as indicating or implying relative importance or implying the number of technical features indicated. Thus, the features defining “first” and “second” may include one or more of the features explicitly or implicitly. In the description of this application, the meaning of “a plurality of” is two or more, unless specifically defined otherwise.

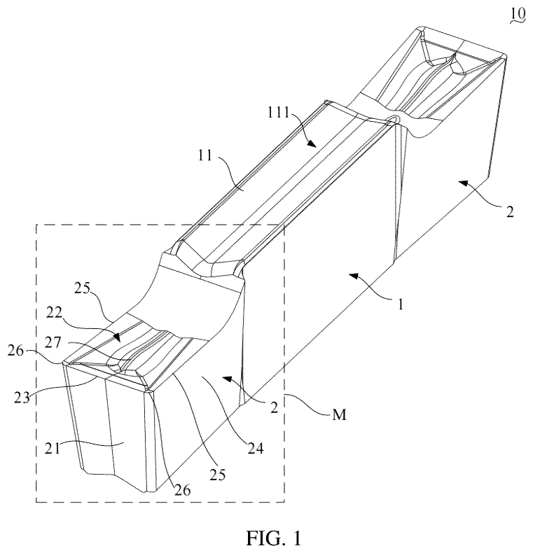

Referring to FIG. 1, the present application provides a cutting insert 10. The cutting insert 10 may be used for performing processing such as grooving on a workpiece. Specifically, in this embodiment, the cutting insert 10 may be used to process materials with relatively low hardness, such as soft steel, aluminum alloy, etc., and the materials with low hardness mentioned above will generate soft chips during the cutting process. The cutting insert 10 of this embodiment allows chips generated by the materials with low hardness to be evacuated more smoothly. It is to be understood that the cutting insert 10 of this embodiment may also be used to process materials with relatively high hardness. The material of the workpiece by the cutting insert 10 is not limited herein.

The cutting insert 10 extends from a front end to a rear end. That is, a longitudinal direction of the cutting insert 10 is oriented in a front-rear direction. As shown in FIG. 1, the cutting insert 10 of this embodiment is in the form of a rod extending along a central axis from a front end side (a left lower side in the figure) toward a rear end side (a right upper side in the figure). The cutting insert 10 of this embodiment is provided with a main body part 1 and two cutting parts 2 along the central axis. The two cutting parts 2 are respectively located at two sides of the main body part 1.

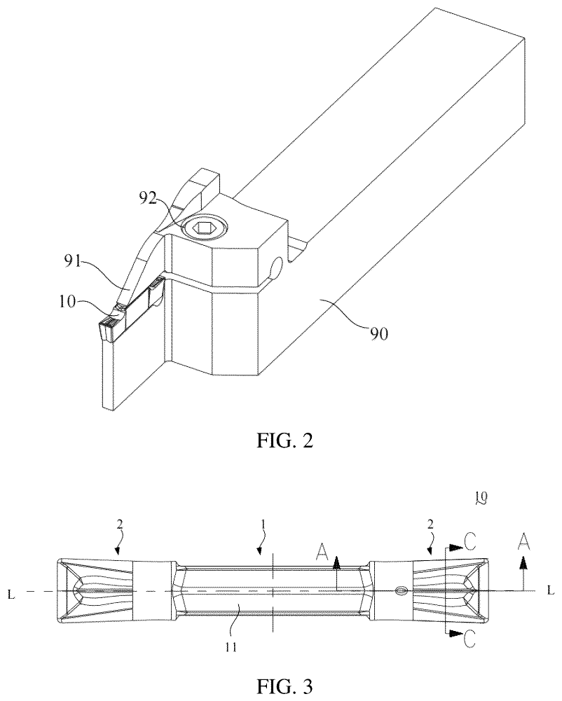

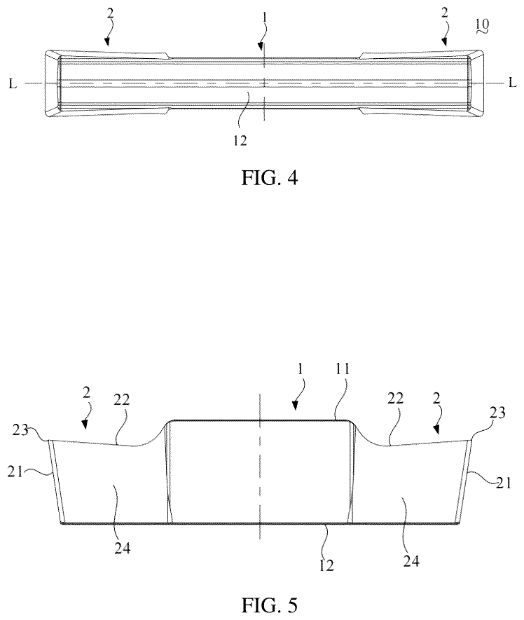

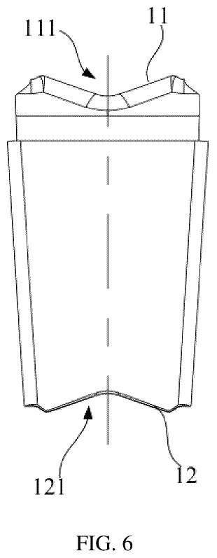

Referring to FIG. 2, the main body part 1 is configured to be fixedly mounted to the shank 90. Referring to FIGS. 3 and 4, the main body part 1 extends along the central axis L. Referring to FIGS. 5 and 6, the main body part 1 has an upper side surface 11 and a lower side surface 12. The upper side surface 11 is formed with a first mounting groove 111 extending along the central axis L. The lower side surface 12 is formed with a second mounting groove 121 extending along the central axis L. The shapes of the first mounting groove 111 and the second mounting groove 121 are adapted to the clamping structure 91 of the shank 90. The clamping structure 91 clamps and limits the upper side surface 11 and the lower side surface 12 of the main body part 1 respectively. The clamping structure 91 fixedly mounts the cutting insert 10 on the shank 90 through a screw 92. Furthermore, the clamping force from the clamping structure 91 onto the main body part 1 of the cutting insert may also be adjusted by rotating the screw 92.

The two cutting parts 2 are respectively located at two sides of the main body part 1. When the cutting insert 10 is mounted on the shank 90, the cutting part 2 on one side may be protruded from a tool seat on the shank 90, then the cutting part 2 may perform cutting. After the cutting part 2 on the side in use is worn out during the cutting, the cutting part 2 on the other side may be replaced for cutting. The two cutting parts 2 may be of the same implementation or of two different implementations.

Referring to FIG. 1, each cutting part 2 includes a front surface 21, an upper surface 22, a front cutting edge 23, a side surface 24 and a side cutting edge 25.

The front surface 21 is located at the front end of the cutting part 2. The upper surface 22 is connected to the front surface 21.

The front cutting edge 23 is located at an intersection of the upper surface 22 and the front surface 21. The front cutting edge 23 functions as a main cutting portion when performing grooving, and the front cutting edge 23 is configured to perform longitudinal cutting on an outer surface of the workpiece.

The side surface 24 may be connected to the front surface 21 and the upper surface 22, respectively. The number of side surfaces 24 may be two, and the side surfaces 24 are respectively located on two sides of the upper surface 22 and the front surface 21.

Side cutting edges 25 are located at intersections of the side surfaces 24 and the upper surface 22, respectively. The number of side cutting edges 25 may also be two, and the side cutting edges 25 are respectively located on the two sides of the upper surface 22 of the cutting part 2. The side cutting edges 25 are configured to perform transverse cutting on the workpiece.

In other embodiments, according to different requirements, the number of side cutting edge 25 may be one, i.e., the side cutting edge 25 may be disposed at the intersection of the upper surface 22 and one of the side surfaces 24.

In this embodiment, rounded cutting edges 26 are provided at transitional junctions between the front cutting edge 23 and the side cutting edges 25. The rounded cutting edges 26 enable transition between the front cutting edge 23 and the side cutting edges 25 smoothly and maintain continuity. A pair of rounded cutting edges 26 are disposed at both ends of the front cutting edge 23, and are configured to face each other with the front cutting edge 23 interposed therebetween.

The workpiece is processed by the front cutting edge 23 and the side cutting edges 25, forming chips and curled chips on the upper surface 22, which are finally evacuated from the upper surface 22.

In the front-rear direction, the upper surface 22 is sequentially provided with a plurality of front regions starting from the front cutting edge 23. Each front region is a spatial region, which may be a curved surface with a radius, or a flat inclined surface, or a combination of the inclined surface and the curved surface.

In a direction from the side cutting edges 25 to the central axis L, the upper surface 22 is provided with a plurality of side regions arranged sequentially starting from the side cutting edges 25. Each side region is a spatial region, which may be a curved surface with a radius, or a flat inclined surface, or a combination of the inclined surface and the curved surface.

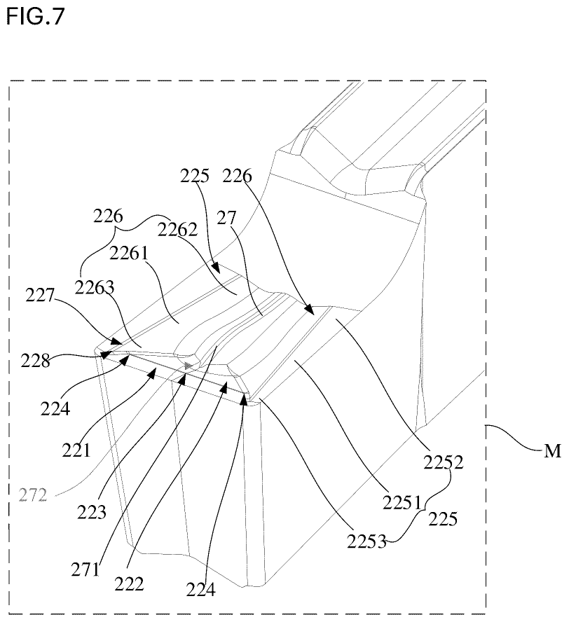

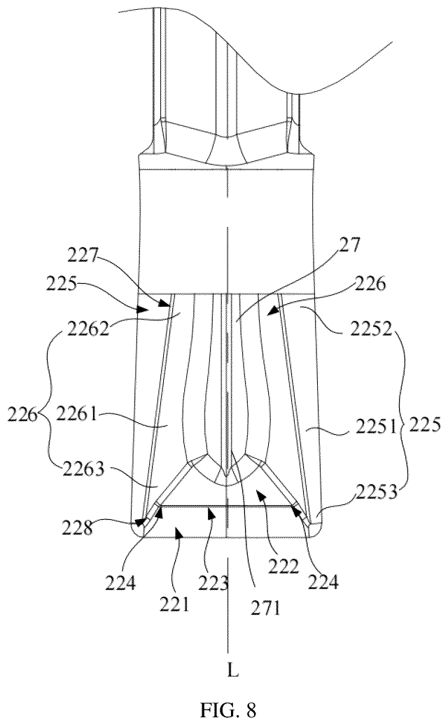

Referring to FIGS. 7 and 8, in this embodiment, the upper surface 22 includes a first front region 221 and a second front region 222. The first front region 221 is connected to the front cutting edge 23 and is inclined downward. The second front region 222 is connected to the first front region 221, extends rearward from the first front region 221, and is inclined more downward relative to the first front region 221. That is, the second front region 222 is inclined downward to a greater degree relative to the first front region 221. Therefore, when the chips move from the first front region 221 to the second front region 222, the second front region 222 has a relatively large space because the second front region 222 is inclined downward more steeply, which facilitates the chip-curling and enables the chips to be evacuated more smoothly. Furthermore, the first front region 221 may ensure the strength of the front cutting edge 23 and the overall rigidity of the cutting insert 10.

A junction between the first front region 221 and the second front region 222 is defined as a front junction region 223. The front junction region 223 is a smooth transitional surface to facilitate the movement of the chips from the first front region 221 to the surface of the second front region 222. Ends of the front junction region 223 close to the side cutting edges 25 are defined as first ends 224. The first ends 224 are located on two sides of the junction of the front junction region 223, respectively.

Specifically, in this embodiment, the upper surface 22 further includes a first side region 225 and a second side region 226. The first side region 225 is connected to the side cutting edge 25 and is inclined downward. The first side region 225 extends from the side cutting edge 25 in a direction toward the central axis L, and the first side region 225 is inclined downward. The second side region 226 is connected to the first side region 225, the second side region 226 extends from the first side region 225 in the direction toward the central axis L, and the second side region 226 is inclined downward more steeply relative to the first side region 225. That is, the second side region 226 is inclined downward to a greater degree relative to the first side region 225. Therefore, when chips are moved from the first side region 225 to the second side region 226, since the second side region 226 is inclined downward more steeply, the space of the second side region 226 is relatively large, which facilitates the chip-curling and enables the chips to be evacuated more smoothly.

A junction between the first side region 225 and the second side region 226 is defined as a side junction region 227. The side junction region 227 is a smooth transitional surface to facilitate the movement of chips from the first side region 225 to the surface of the second side region 226. An end of the side junction region 227 close to the front cutting edge 23 is defined as a second end 228.

Specifically, in this embodiment, the first ends 224 are further away from the front cutting edge 23 than the second end 228. Further, the first ends 224 are further away from the side cutting edge 25 than the second end 228. Thus, the second side region 226 may contact the chips earlier than the second front region 222. The two sides of chips may be brought into contact with the second side region 226 earlier, and the two sides of each of the chips are curled in the direction toward the central axis L by means of the second side region 226. Therefore, the two sides of each of the chips are curved upward in advance before the chips are curled downward into the second front region 222. The chips facilitate the overall curling and shaping of the chips.

The front junction region 223 as a whole is further away from the front cutting edge 23 than the second end 228. The front junction region 223 and the front cutting edge 23 are approximately parallel to each other. That is, a distance between the front junction region 223 and the front cutting edge 23 is greater than a distance between the second end 228 and the front cutting edge 23. Thus, the second end 228 of the side junction region 227 is closer to the front cutting edge 23. Therefore, during the transition of chips formed by the front cutting edge 23 from the first front region 221 to the second front region 222, chips on the two sides of the first front region 221 will firstly contact with the second end 228, and transition toward the second front region 222 after being constrained by the second end 228.

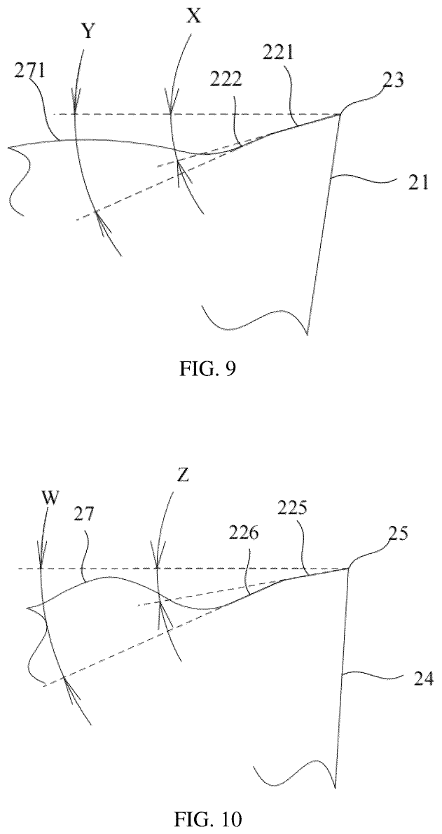

Further, in order to facilitate the description of the inclination of the first front region 221 and the second front region 222, the first side region 225 and the second side region 226, now the first front region 221, the second front region 222, the first side region 225 and the second side region 226 are approximated as inclined planes. That is, the first front region 221 and the second front region 222 are flat, respectively. The first side region 225 and the second side region 226 are flat, respectively. The downward inclination angles of the inclined planes may specify the inclination of the first front region 221, the second front region 222, the first side region 225 and the second side region 226. That is, for convenience of explanation, referring to FIGS. 9 and 10, the downward inclination angle of the first front region 221 is defined as a first inclination angle X. The downward inclination angle of the second front region 222 is defined as a second inclination angle Y. The downward inclination angle of the first side region 225 is defined as a third inclination angle Z. The downward inclination angle of second side region 226 is inclined downward is defined as a fourth inclination angle W. According to the above description, the first inclination angle X is less than the second inclination angle Y; and the third inclination angle Z is less than the fourth inclination angle W.

Specifically, in this embodiment, a height of each of the first ends 224 is lower than a height of the second end 228, and the first ends 224 are positioned below the second end 228. That is, the first inclination angle X of the first front region 221 is greater than the third inclination angle Z of the first side region 225. Specifically, the first inclination angle X ranges from 10°-20°, and the third inclination angle Z ranges from 5°-15°.

Further, the second inclination angle Y ranges from 15°-30°, and the fourth inclination angle W ranges from 15°-30°.

Specifically, in this embodiment, the fourth inclination angle W has a significant impact on the chip constraint effect. When the fourth inclination angle W is too small, the portion of the front end of the second side region 226 which has a restraining effect will move rearward; it is not good for the restriction and curling of the chip. When the fourth inclination angle W is too large, the second side region 226 fails to make sufficient contact with chips, leading to a reduction in the constraint effect.

Specifically, in this embodiment, when the fourth inclination angle W is 24°, the controlling of the chips is better, and when the fourth inclination angle W is too large, the area of the second side region 226 will instead decrease.

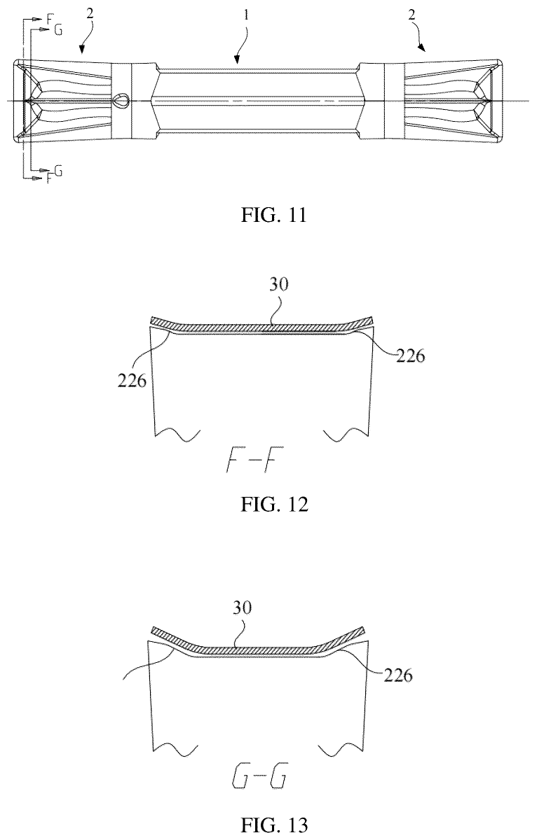

Referring to FIGS. 11, 12 and 13, FIG. 12 is a sectional view taken along line F-F, and FIG. 13 is a sectional view taken along line G-G. As can be seen in section G-G, a depth of the second front region 222 increases as the distance from the front cutting edge 23 increases, the chip evacuation space is increased, and meanwhile, the contact area between the second front region 222 and the chips is also increased.

During grooving, the chips 30 are evacuated along the upper surfaces 22 of the first front region 221 and the second front region 222; meanwhile, the chips 30 on the two sides will generate a reaction force due to the protrusions of the first side region 225 and the second side region 226, generating a reaction force and allowing the chips 30 to bend upward.

In the process of evacuating the chips 30 from section F-F to section G-G, as the section position of the second side region 226 is increased, when the chips 30 are contacted to the second side region 226, the chips 30 will also be subjected to an increased acting force from the second side region 226 as the contact position is increased, and under the acting force of the second side region 226, the chips 30 are more prone to an upward being phenomenon.

Referring again to FIGS. 7 and 8, the first side region 225 extends in the direction of the central axis L. In the front-rear direction, the first side region 225 has a third outer part 2253, a first outer part 2251 and a second outer part 2252 arranged sequentially. The third outer part 2253 is closest to the front cutting edge 23. The first outer part 2251 is located between the third outer part 2253 and the second outer part 2252. The second outer part 2252 is further away from the front cutting edge 23 than the first outer part 2251, and the second outer part 2252 is furthest away from the front cutting edge 23.

The first side region 225 extends rearward from the front cutting edge 23 in a direction of the central axis L of the cutting insert 10, and the width of the first side region 225 is increased gradually. The “width” herein is to be understood as a size of a distance in a direction of the side cutting edge 25 towards the central axis L. That is, a width of the third outer part 2253 is less than a width of the first outer part 2251, and a width of the first outer part 2251 is less than a width of the second outer part 2252.

The first outer part 2251 is further away from the front cutting edge 23 than the second front region 222. Therefore, the first outer part 2251 is specifically positioned behind the second front region 222. The width of the first outer part 2251 is less than a width of the first front region 221. The width of the second outer part 2252 is greater than the width of the first front region 221.

The second side region 226 has a first inner part 2261 and a second inner part 2262. The first inner part 2261 is connected to the first outer part 2251, and the second inner part 2262 is connected to the second outer part 2252. The width of the first outer part 2251 is less than a width of the first inner part 2261.

The first outer part 2251 and the first inner part 2261 are further away from the front cutting edge 23 than the second front region 222. And the width of the second outer part 2252 is greater than a width of the second inner part 2262. In the direction of the central axis L, the widths of the first inner part 2261 and the second inner part 2262 are decreased from front to rear.

The side region may restrict the chip, under the combined effect of variation of the width of the first side region 225 and the restriction of the second side region 226, the chips in the second side region 226 are guided in the direction toward the central axis to move from the first inner part 2261 to the second inner part 2262 as they move away from the front cutting edge 23, and finally evacuated smoothly.

Specifically, in this embodiment, the second side region 226 further includes a third inner part 2263. The third inner part 2263 is closer to the front cutting edge 23 than the first inner part 2261. The third inner part 2263 is disposed opposite to the third outer part 2253, and the third inner part 2263 is connected to the third outer part 2253.

The third inner part 2263 may smoothly connect the first front region 221, the second front region 222 and the second side region 226. The side of the third inner part 2263 close to the first side region 225 is connected to the second side region 226. The other side of the third inner part 2263 is connected to the first front region 221 and the second front region 222. A maximum width of the third inner part 2263 is greater than the width of the third outer part 2253. The structure of the third inner part 2263 is a chamfered arc-shaped curved surface. The third inner part 2263 forms an inclined surface with an inclined tendency. The inclined surface facilitates the chips to be evacuated in one direction and it is not easily to occur the phenomenon of chip entanglement.

Specifically, a chamfered curved surface is provided at the junction between the third inner part 2263 and the first front region and the second front region, and the curvature radius R may be within the range of 0.1 mm≤R≤0.2 mm. If the radius of curvature R of the third inner part 2263 is relatively large, the position of the second side region 226 is moved rearward away from the front cutting edge 23; meanwhile, the area of the second side region 226 is reduced. The third inner part 2263 may increase the area of the second side region 226 and the second front region 222, while ensuring that the position of the second side region 226 is moved forward, closer to the front cutting edge 23. During grooving by a grooving insert, the second side region 226 may restrict the chips earlier. Therefore, the chips may be effectively curled by the cutting insert 10, so that the chips may be evacuated more smoothly without interfering with a side surface of a groove of the workpiece.

The upper surface 22 of the cutting insert 10 is provided with a protrusion 27 between the cutting edges 25 on both sides. The protrusion 27 is centrally positioned on the upper surface 22 of the cutting insert 10. The protrusion 27 is located on the central axis of the cutting insert 10. The two side cutting edges 25 are symmetrically disposed on two sides of the protrusion 27, respectively. The side regions are disposed between the protrusion 27 and the side cutting edges 25. Therefore, the distance between the protrusion 27 and the front cutting edge 23, and the distance between the side cutting edges 25 on the two sides are moderate, and the chips may be smoothly moved on the upper surface of the cutting insert 10. Thus, the protrusion 27 facilitates controlling the chips to be evacuated in one direction and it is not easily to occur the phenomenon of chip entanglement.

The protrusion 27 is elongated and extends in the direction of the central axis. The height of the protrusion 27 is gradually changed. The “height” herein may be a distance in a vertical direction. Specifically, the height of the protrusion 27 is gradually increased in the direction from the rear to the front. And a peak 271 is formed at a front end of the protrusion 27, and a front side surface 272 of the peak 271 gradually slopes downward and is in transitional connection with the second front region 222. The height of the protrusion 27 at the peak 271 is relatively high, so that the chips pass through the first front region 221 and the second front region 222, and are curled in a specific shape and orientation at the peak 271 of the protrusion 27, facilitating the direct evacuation of the chips.

The height of the peak 271 is lower than the height of the side cutting edge 25. The “lower” herein is to be understood that the height of the peak 271 is close to and lower than the height of the side cutting edge 25. That is, according to the side view of the cutting insert 10, the protrusion 27 is obstructed by the side cutting edge 25. In addition, the position where the protrusion 27 intersects with the second front region 222 ensures sufficient space for chip-curling, facilitating the reduction of the chip adhesion phenomenon.

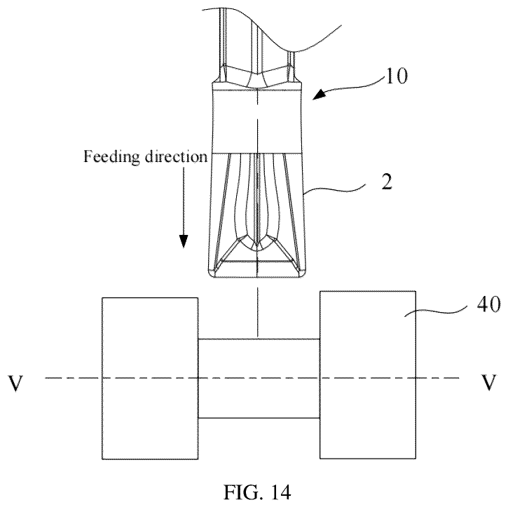

The curling of chips generated by the cutting insert 10 is described below considering the different condition of the cutting insert 10, taking the workpiece as a cylinder for illustration. When the cutting insert 10 of this embodiment performs grooving on the cylindrical workpiece 40, referring to FIG. 14, the cutting insert 10 enters in a direction perpendicular to the axial direction V of the cylinder to perform grooving. The front cutting edge 23 of the cutting insert 10 contacts the workpiece, chips are translated from the front cutting edge 23 toward the first front region 221, the first front region 221 is inclined downward, and the chips are moved obliquely downward along the first front region 221. When chips pass through the first front region 221, the two sides of each of the chips pass through the second end 228 on the two sides of the first front region 221. The second end 228 is closer to the front cutting edge 23, and the height of the second end 228 is also higher than the height of the second front region 222, and the two sides of each of the chips are in contact with the second end 228, and the both sides of chips are curled in the direction of the central axis. The chips pass through the second end 228, and the two sides of each of the chips are in contact with the second side region 226. The chips enter from the third inner part 2263 of the second side region 226, the third inner part 2263 is connected to the third outer part 2253. The spatial distance between the two third inner parts 2263 on the left and right sides is also gradually decreased due to the gradual increase of the third outer part 2253 in the direction away from the front cutting edge 23. The chips 30 on the two sides are bent upward along a plane of the third inner part 2263 and are pressed toward the central axis by means of two third inner parts 2263. Also, during the chips moving rearwards along the first inner part 2261 and the second inner part 2262 through the third inner part 2263, since the width from the first inner part 2261 to the second inner part 2262 is gradually decreased, the chips may be guided to gradually approach the central axis.

The chips move along the central axis direction, pass through the first front region 221 and the second front region 222, move to the front side surface 272 of the front end of the protrusion 27, and move upward along the front side surface 272 to the peak 271, so that the chips are curled and evacuated upwards regularly by the protrusion 27. By the combined effect of various aspects, the chips are pressed toward the central axis, and are curled and evacuated upwards without interfering with wall surfaces on the two sides of the groove of workpiece.

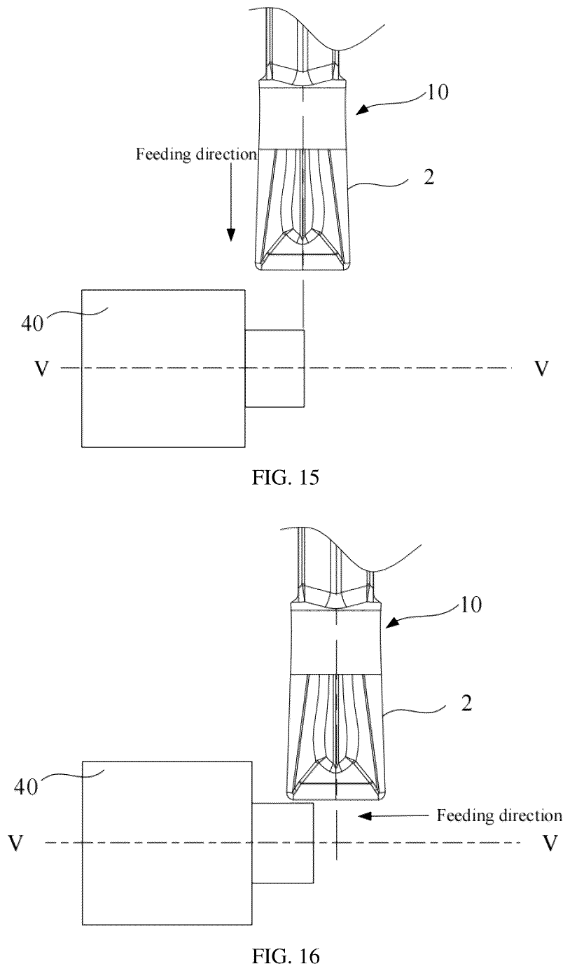

When the cutting insert 10 of this embodiment performs shoulder grooving on the cylindrical workpiece 40, referring to FIG. 15, the cutting insert 10 is fed in a direction perpendicular to the axial direction V of the cylinder for cutting. A portion of the front cutting edge 23 of the cutting insert 10 is in contact with the workpiece. The formed chips will also be bent upward along the plane of the third inner part 2263 by means of the third inner part 2263, and are pressed toward the central axis. When the chips close to the central axis pass through the first front region 221 and the second front region 222 and move to the front side of the front end of the protrusion 27 or the inclined surface of the side end of the protrusion 27, the chips move upward along the front side or the inclined surface to the peak 271, so that the chips are curled upwards regularly and evacuated under the action of the protrusion 27. Under the action of both the second side region 226 and the protrusions 27, the chips are brought together in the direction toward the central axis, and are finally evacuated in the direction of the central axis.

When the cutting insert 10 of this embodiment performs transverse cutting on the cylindrical workpiece 40, referring to FIG. 16, the cutting insert 10 is fed in a direction parallel to the axial direction V of the cylinder for cutting. The side cutting edge 25 of the cutting insert 10 contacts the workpiece, chips are translated from the side cutting edge 25 toward a first side region 225, the first side region 225 is inclined downward more steeply, and the chips are curled obliquely downward along the first side region 225. The second side region 226 is inclined downward more steeply than the first side region 225. Thus, the space of the second side region 226 is increased, which ensures sufficient space for the chips to move through the second side region 226.

The width of the first side region 225 gradually increases in the direction away from the front cutting edge 23, so that there is a difference in order when the chips enter the second side region 226. Chips close to the third outer part 2253 first enter the second side region 226; and chips close to the second outer part 2252 then enter the second side region 226. Thus, the movable space for the chips entering the third inner part 2263 is greater than that for the chips entering the second inner part 2262. Therefore, under the combined action of the protrusion 27 with higher in front and lower in rear, the curling radius of the chips at the third inner part 2263 is greater than that of the chips at the second inner part 2262. Due to these differences, the chips are curled and evacuated in a direction away from the front cutting edge 23, without interfering with a processed surface of the workpiece. Therefore, the cutting part 2 of the cutting insert 10 of this embodiment, through the first front region 221 and the second front region 224 inclined downward more steeply, and the first side region 225 and the second side region 226 inclined downward more steeply, increases the receiving space for chips and ensures sufficient space for curling the chips, facilitating the reduction of the chip adhesion phenomenon.

Furthermore, the first end 224 is further away from the front cutting edge 23 than the second end 228, so that the second side region 226 is closer to the front cutting edge 23, the second side region 226 may contact the chips earlier, facilitating inward curling and shaping of the chips, so that the chips may extend in a specific direction, and be smoothly evacuated, avoiding the occurrence of chip adhesion.

Although the present invention has been described with reference to several exemplary embodiments, it should be understood that the terms used are illustrative and exemplary, and not limiting. Since the present invention may be embodied in a variety of forms without departing from the spirit or essential characteristics, it should be understood that the foregoing embodiments are not limited to any of the foregoing details, but should be broadly construed within the spirit and scope defined by the appended claims, thus, all variations and modifications falling within the scope of the appended Claims are intended to be embraced by the appended claims.

1. A cutting insert extending from a front end to a rear end, comprising:
a front surface located at the front end,
an upper surface connected to the front surface,
a side surface connected to the front surface and the upper surface,
a front cutting edge located at an intersection of the front surface and the upper surface, and
a side cutting edge located at an intersection of the side surface and the upper surface;
the upper surface comprises:
a first front region connected to the front cutting edge and inclined downward,
a second front region connected to the first front region and inclined downward,
a first side region connected to the side cutting edge and inclined downward,
a second side region connected to the first side region and inclined downward;
wherein an end of a junction between the first front region and the second front region, close to the side cutting edge is defined as a first end,
an end of the junction between the first side region and the second side region, close to the front cutting edge is defined as a second end, and
the first end is further away from the front cutting edge than the second end.

2. The cutting insert according to claim 1, wherein the junction between the first front region and the second front region as a whole is further away from the front cutting edge than the second end.

3. The cutting insert according to claim 1, wherein a height of the first end is lower than a height of the second end, and the first end is located below the second end.

4. The cutting insert according to claim 1, wherein the first end is further away from the side cutting edge than the second end.

5. The cutting insert according to claim 1, wherein the first front region and the second front region are flat, respectively.

6. The cutting insert according to claim 1, wherein the first side region and the second side region are flat, respectively.

7. The cutting insert according to claim 1, wherein
the first side region comprises a first outer part and a second outer part further away from the front cutting edge than the first outer part;
the second side region comprises a first inner part and a second inner part, the first inner part is connected to the first outer part, and the second inner part is connected to the second outer part;
the first outer part and the first inner part are further away from the front cutting edge than the second front region; and
a width of the first outer part is less than a width of the first inner part, and a width of the second outer part is greater than a width of the second inner part.

8. The cutting insert according to claim 7, wherein
the first side region comprises a third outer part, which is closer to the front cutting edge than the first outer part;
the second side region comprises a third inner part, which is closer to the front cutting edge than the first inner part;
the third inner part is connected to the first front region and the second front region, respectively; and
a maximum width of the third inner part is greater than a width of the third outer part.

9. The cutting insert according to claim 7, wherein the width of the first outer part is less than a width of the first front region, and the width of the second outer part is greater than the width of the first front region.

10. The cutting insert according to claim 1, wherein
the upper surface further comprises a protrusion located between the two side cutting edges and extends from a side of the rear end to a side of the front end,
the protrusion comprises
a peak having the highest height in the protrusion and located at a side of the front end, and
a front side surface which is connected to the peak and the second front region and gradually slopes downward.

11. The cutting insert according to claim 10, wherein a height of the peak is lower than a height of the side cutting edge.
